(19) United States
(12) Patent Application Publication
(10) Pub. No.: US 2019/0188092 A1
(43) Pub. Date: Jun. 20, 2019

(54) MEMORY ERROR RECOVERY

(71) Applicant: International Business Machines Corporation, Armonk, NY (US)

(72) Inventor: ARAVINDA PRASAD, Mysore (IN)

(21) Appl. No.: 15/846,528

(22) Filed: Dec. 19, 2017

(51) Int. Cl. G06F 11/14

(52) U.S. Cl. CPC G06F 11/1469; G06F 2201/82; G06F 2201/805; G06F 11/1451

(57) ABSTRACT

DRAM errors that are not correctable automatically when detected are handled by replacing corrupt data with replacement data obtained in a cache of the computer system in which the DRAM error is detected. Cached data includes copied datasets and corresponding memory addresses for identifying the copied data from a location where an uncorrected DRAM error occurs. Searching the cache by address identifies the replacement data.

### BACKGROUND

The present invention relates generally to the field of computer memory management, and more particularly to recovering data in a computer system experiencing an uncorrected memory error.

Dynamic random-access memory (DRAM) is a type of random-access memory (RAM) that stores each bit of data in a separate capacitor within an integrated circuit. The capacitor is charged or discharged to represent the two values of a bit, conventionally called 0 and 1. Capacitors discharge over time due to inevitable leakage, so the information stored in a capacitor eventually fades unless the capacitor charge is refreshed periodically. The refresh requirement is what makes the DRAM “dynamic” as opposed to static random-access memory (SRAM) and other types of static memory.

DRAM errors are a common form of hardware failure in modern computer systems. A DRAM error, also referred to herein as a memory error, is an event that leads to the corruption of one or more bits in the memory. Memory errors can be caused by electrical or magnetic interference (e.g. due to cosmic rays), can be due to problems with the hardware (e.g. a bit being permanently damaged), or due to corruption along the data path between the memories and the processing elements.

Enterprise systems employ various mechanisms to recover from DRAM errors. The recovery mechanism can be in the hardware or the software. At the hardware level, Error Correcting Codes (ECC) are used to recover from single-bit DRAM errors. Other techniques are used to recover from multi-bit DRAM errors.

### SUMMARY

In one aspect of the present invention, a method, a computer program product, and a system includes: (i) intercepting an non-maskable exception report within a computer system, the non-maskable exception report identifying a memory error including a memory address of a corrupt page in a memory of the computer system; (ii) causing at least one of a firmware of the computer system and an operating system of the computer system to search a set of cached data for a replacement copy of the corrupt page, the replacement copy being a clean dataset corresponding to the corrupt page; (iii) responsive to locating the replacement copy, retrieving the replacement copy; (iv) storing the replacement copy in the memory; and (v) recovering the computer system from the memory error.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system; and

FIG. 3 is a block diagram view of a machine logic (e.g., software) portion of the first embodiment system.

### DETAILED DESCRIPTION

DRAM errors that are not correctable automatically when detected are handled by replacing corrupt data with replacement data obtained in a cache of the computer system in which the DRAM error is detected. Cached data includes copied datasets and corresponding memory addresses for identifying the copied data from a location where an uncorrected DRAM error occurs. Searching the cache by address identifies the replacement data. This Detailed Description section is divided into the following sub-sections: (i) Hardware and Software Environment; (ii) Example Embodiment; (iii) Further Comments and/or Embodiments; and (iv) Definitions.

### I. HARDWARE AND SOFTWARE ENVIRONMENT

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

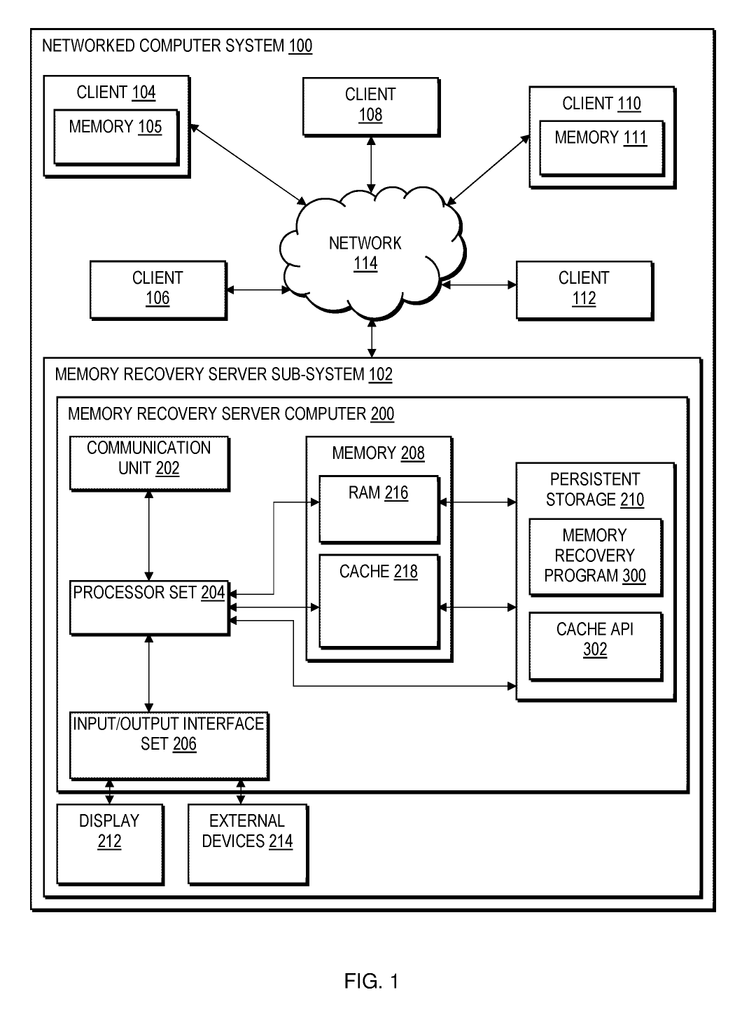

An embodiment of a possible hardware and software environment for software and/or methods according to the present invention will now be described in detail with reference to the Figures. FIG. 1 is a functional block diagram illustrating various portions of networked computers system 100, including: memory recovery server sub-system 102; client sub-systems 104, 106, 108, 110, 112; memory 105, 111; and communication network 114. Memory recovery server sub-system 102 contains: memory recovery server computer 200; display device 212; and external devices 214. Memory recovery server computer 200 contains: communication unit 202; processor set 204; input/output (I/O) interface set 206; memory device 208; and persistent storage device 210. Memory device 208 contains: random access memory (RAM) devices 216; and cache memory device 218. Persistent storage device 210 contains: memory recovery program 300 and cache API 302.

Memory recovery server sub-system 102 is, in many respects, representative of the various computer sub-systems in the present invention. Accordingly, several portions of memory recovery server sub-system 102 will now be discussed in the following paragraphs.

Memory recovery server sub-system 102 may be a laptop computer, a tablet computer, a netbook computer, a personal computer (PC), a desktop computer, a personal digital assistant (PDA), a smart phone, or any programmable electronic device capable of communicating with client sub-systems via communication network 114. Memory recovery program 300 is a collection of machine readable instructions and/or data that is used to create, manage, and control certain software functions that will be discussed in detail, below, in the Example Embodiment sub-section of this Detailed Description section.

Memory recovery server sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between server and client sub-systems.

Memory recovery server sub-system 102 is shown as a block diagram with many double arrows. These double arrows (no separate reference numerals) represent a communications fabric, which provides communications between various components of memory recovery server sub-system 102. This communications fabric can be implemented with any architecture designed for passing data and/or control information between processors (such as microprocessors, communications processors, and/or network processors, etc.), system memory, peripheral devices, and any other hardware components within a system. For example, the communications fabric can be implemented, at least in part, with one or more buses.

Memory device 208 and persistent storage device 210 are computer readable storage media. In general, memory device 208 can include any suitable volatile or non-volatile computer readable storage media. It is further noted that, now and/or in the near future: (i) external devices 214 may be able to supply some, or all, memory for memory recovery server sub-system 102; and/or (ii) devices external to memory recovery server sub-system 102 may be able to provide memory for memory recovery server sub-system 102.

Memory recovery program 300 is stored in persistent storage device 210 for access and/or execution by one or more processors of processor set 204, usually through memory device 208. Persistent storage device 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage device 210.

Memory recovery program 300 may include both substantive data (that is, the type of data stored in a database) and/or machine readable and performable instructions. In this particular embodiment (i.e., FIG. 1), persistent storage device 210 includes a magnetic hard disk drive. To name some possible variations, persistent storage device 210 may include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer readable storage medium that is also part of persistent storage device 210.

Communication unit 202, in these examples, provides for communications with other data processing systems or devices external to memory recovery server sub-system 102. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

I/O interface set 206 allows for input and output of data with other devices that may be connected locally in data communication with memory recovery server computer 200. For example, I/O interface set 206 provides a connection to external devices 214. External devices 214 will typically include devices, such as a keyboard, a keypad, a touch screen, and/or some other suitable input device. External devices 214 can also include portable computer readable storage media, such as, for example, thumb drives, portable optical or magnetic disks, and memory cards. Software and data used to practice embodiments of the present invention (e.g., memory recovery program 300) can be stored on such portable computer readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

Some embodiments of the present invention recognize the following facts, potential problems, and/or potential areas for improvement with respect to the current state of the art. (i) critical kernel and application data structures are frequently accessed and the probability of the data in L1/L2/L3 caches is high; (ii) when a UE occurs at critical data structure locations in memory, there is a fair chance that the data is already cached in these caches; (iii) techniques such as memory mirroring can be used to recover from a UE, but a drawback of full memory mirroring is that it will reduce the total memory capacity of the system by 50% and it includes additional overhead of updating and maintaining the additional copy; and/or (iv) Partial memory mirroring has an overhead relative to the number of memory pages mirrored, but memory mirroring techniques cannot be used for kernel data pages because the kernel data pages (at least in the case of the Linux kernel) maps directly to the physical frames.

Hardware cannot recover from all kinds of DRAM errors, or memory errors. For example, hardware cannot recover from errors where the number of affected bits exceeds a limit of what ECCs can correct. Memory errors that are automatically detected and corrected by hardware are referred to as Corrected Errors (CE). Those memory errors that are detected by hardware, but cannot be automatically corrected are referred to as Uncorrected Errors (UE). UEs are passed on to the software (e.g. firmware, kernel) through a non-maskable interrupt. The software employs various methods to recover from UEs depending on the location of the UE. Not every UE can be recovered at the software level. Because a UE leads to data corruption, whenever a UE is encountered the firmware or OS panics and eventually a system crash occurs. Handling UEs is important from the systems availability stand point as UEs lead to system crash.

The main problem with a UE is data corruption. If the corrupted data is part of a critical or sensitive data structure, the system or application cannot continue executing, so a system crash is triggered when a UE arises. There are very few techniques available to recover from UEs. If the UE happens on a file (non-dirty) or text page, the associated page on which an UE happened is discarded and the contents of the page are reloaded into new memory location from disk. The page in error is permanently off-lined and the page table entries are suitably updated. If the UE happens on a memory page belonging to a user application a signal (SIGBUS) is sent to the user application. This avoids bringing down the entire system, however, the application crashes in such cases. If the page in error belongs to the kernel data, then there is no other option but to trigger panic.

Scenarios where an uncorrected error is detected are broadly classified as synchronous and asynchronous error detection. Synchronous error detection is where a UE is detected during memory read operations. However, UEs are also detected during write operations in flash memory such as Multi Cell Memory (MLC) which employs write-after-verify schemes. In write-after-verify, the value written to the memory is read to verify the contents and UE is triggered in case of data corruption is noticed during verify. Asynchronous error detection is where a UE is detected during background memory scrubbing. Background memory scrubbing consists of reading each memory location, correcting bit errors (if any) with an error-correcting code (ECC), and writing the corrected data back to the same location. Uncorrected errors are identified during background scrubbing if the hardware is unable to correct the bit errors.

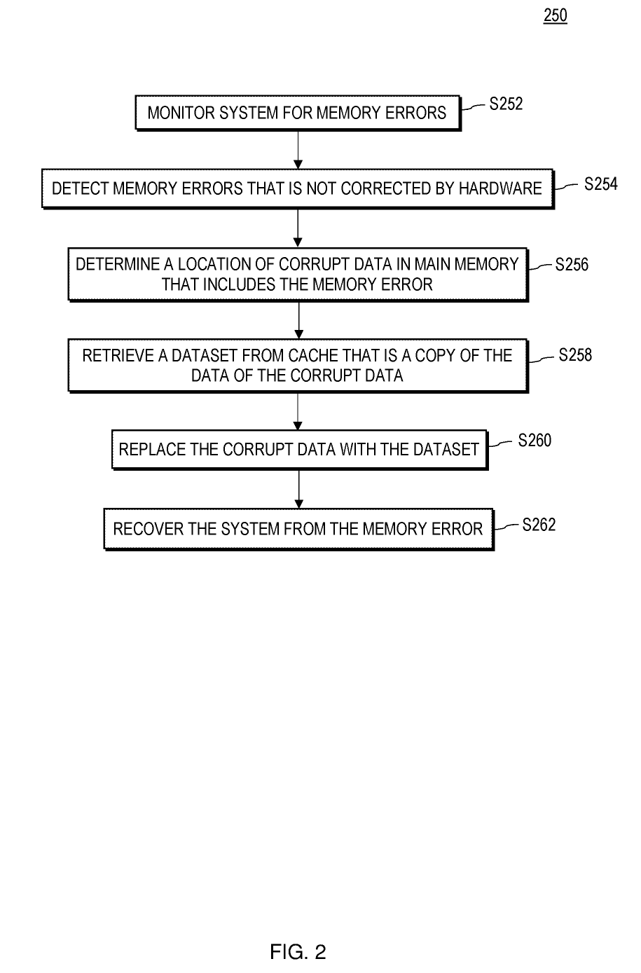

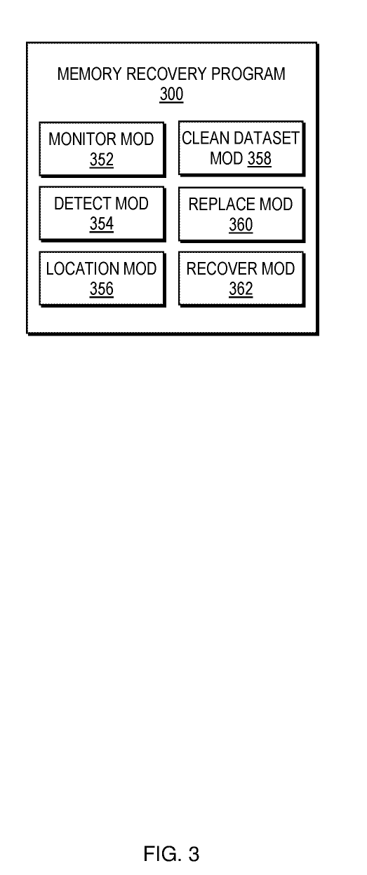

FIG. 2 shows flowchart 250 depicting a method according to the present invention. FIG. 3 shows search context program 300, which performs at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S252, where monitor module (“mod”) 352 monitors system for memory errors.

Processing proceeds to operation S254, where detect mod 354 detects memory error that is not corrected by hardware. As discussed above some memory errors are not correctable upon detection and are referred to herein as “uncorrected errors” or UEs. Such UEs are passed on to the software (firmware or operating system) by the hardware via a non-maskable exception for further handling. When a UE is passed off to the software, the detect mod detects the memory error according to error information provided by the hardware. In this example, the error information includes the address and/or location of the corrupt data. Alternatively, the error information identifies the error as a non-maskable exception to trigger processing according to some embodiments of the present invention.

Processing proceeds to operation S256, where clean dataset mod 356 retrieves a data set from cache that is a copy of the data that is representative of the corrupt data. In this example, the clean dataset mod causes the operating system and/or firmware to search the system cache for a clean copy of the corrupt data and, when it is found, retrieves the located data as a replacement dataset. While this example is illustrated as having a program stored in persistent storage to cause the operating system and/or firmware to perform the search, other embodiments of the present invention include the program as part of the operating system and/or as part of the firmware. The search is performed based on the address and/or location of the corrupt data provided by detect mod 354 as discussed above.

Processing proceeds to operation S258, where replace mod 358 replaces the corrupt data with the replacement dataset. In this example, when a copy of the data is found in the cache, the replace mod discards the corrupt data. The replace mod stores the replacement dataset in a new memory location. In that way, a clean copy of the corrupt data is available for use by the system.

Processing proceeds to operation S260, where recover mod 360 recovers the system from the memory error. In this example, when the recover mod recovers the system, the data structures such as page table entries are updated to point to the new memory location. According to some embodiments of the present invention, the corrupt page associated with the corrupt memory address and/or location is offlined. When the system recovers from the memory error in this way, execution of the processors continues.

Some embodiments of the present invention are directed to recovering corrupted data when an uncorrected error occurs. A data recovery technique disclosed herein is to search in the system for a copy of the data that is corrupted by the UE. In a modern computer system there are multiple hierarchy of caches such as L1, L2, and L3 caches that cache recently accessed data. These caches may contain copies of data at the address in error for data recovery. Accordingly, a search is performed in the caches to find the address in error. If the address is found, the data is recovered from the cache to replace the corrupted data.

Some embodiments of the present invention are directed to a technique to recover from uncorrected errors by searching caches of an entire computer system to determine whether or not the location, or address, in error is cached in any of the caches of the system. When the location is found, the corrupted data in the physical memory is recovered from the caches. The process of recovery can be extended to buffers in the devices and CPU registers that also have the copy/copies of the data that is corrupted by a UE.

Some embodiments of the present invention increase the chances of recovering from a UE to reduce system downtime. Avoiding downtime from a UE is required to achieve an enterprise server's expected availability, typically 99.999% availability is expected. Achieving the availability expectation is made possible by avoiding system crashes through automatic recovery from uncorrected errors as they are identified.

For example, in hardware such as X86_64 and POWERPC, a Non-maskable interrupt (NMI) is raised when an UE is detected. The address that caused the UE is set in some register by the hardware before raising an interrupt. In Power architectures DAR is set to the address in error. The disclosed recovery method is called from the NMI context with the address in error as an argument. (Note: the term(s) “X86,” “Power Architecture,” and/or “POWERPC” may be subject to trademark rights in various jurisdictions throughout the world and are used here only in reference to the products or services properly denominated by the marks to the extent that such trademark rights may exist.)

Some embodiments of the present invention may include one, or more, of the following features, characteristics, and/or advantages: (i) recovers from a memory error where the data in main memory is detected to be corrupt due to hardware error and notified to the system; (ii) improved server availability; (iii) natural occurrence of redundant data elements are leveraged to mitigate a data loss and eventually an application or OS shutdown; (iv) offers enhancements to reliability, availability, and serviceability features on enterprise servers; (v) avoids checkstop and non-functioning state of a computing system each time an uncorrected error occurs; (vi) avoids system crash due to machine check errors; (vii) recovers corrupted data from caches; and/or (viii) avoids system crashes by recovering from uncorrected errors.

Some embodiments of the present invention may include one, or more, of the following features, characteristics, and/or advantages: (i) corrupted data is recovered by the operating system; (ii) searches in the cache/buffers/registers of other CPUs or devices for alternative copies of data that has been corrupted; (iii) does not require the memory to be mirrored; and (iv) does not use any parity to recover the data from uncorrected memory error.

A method according to some embodiments of the present invention is presented below in pseudocode. Conventional cache interfaces provide for access to perform the steps noted below. For this reason, a given cache interface is introduced below. Those persons skilled in the art will recognize one or more cache interfaces that make possible the necessary level of access to perform the disclosed methods for recovering from uncorrected DRAM error.

RECOVER_FROM_UE(addr_in_error)

// for a given cache interface:
// miss( ), lineInCache( ) and load( ).
// Check if data pointed by “addr_in_error” is in cache

Step 1: if (miss(addr_in_error)) {

// Data pointed by “addr_in_error” is not in cache.
// Recovery not possible

Step 2: return error;

}
// Data pointed in “addr_in_error” is in cache. Hence,
recover from
//UE.

Step 3: ptr = lineInCache(addr_in_error);
Step 4: data = load (ptr + offset(addr_in_error)).

// Get the old page frame corresponding to the address in
error

Step 5: old_page_frame = addr_to_page(addr_in_error);

// Migrate the contents of the old page frame to the new
page frame.
// Don't copy the data pointed by “addr_in_error” during
migration
// as the data is corrupt.

Step 6: new_page_frame = migrate_page(old_page_frame,
addr_in_error);

// Now “addr_in_error” points to the new_page_frame

Step 7: update_virtual_address_translations(old_page_frame,
new_page_frame);

// Copy the recovered data from cache to the
new_page_frame

Step 8: *addr_in_error = data;

// Offline the old page frame as the bits in the memory are
corrupted

| | |
|---|---|
| Step 9 | page_offline(old_page_frame); |

}

### IV. DEFINITIONS

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

What is claimed is:

1. A method comprising:
intercepting a non-maskable exception report within a computer system, the non-maskable exception report identifying a memory error including a memory address of a corrupt page in a main memory of the computer system;
causing at least one of a firmware of the computer system and an operating system of the computer system to search a set of cached data for a replacement copy of the corrupt page, the replacement copy being a clean dataset corresponding to the corrupt page;
responsive to locating the replacement copy, retrieving the replacement copy;
storing the replacement copy in the memory; and
recovering the computer system from the memory error.

2. The method of claim 1, wherein recovering the computer system from the memory error is performed with no data loss by replacing the corrupt page with the replacement copy.

3. The method of claim 2, wherein replacing the corrupt page includes updating data structures to point to a new memory location.

4. The method of claim 3, wherein the data structures includes page table entries.

5. The method of claim 1, further comprising:
taking the corrupt page offline.

6. The method of claim 1, wherein the memory error is an uncorrected error not corrected by hardware.

7. The method of claim 6, wherein the memory error is a dynamic random-access memory (DRAM) error.

8. The method of claim 1, wherein intercepting a non-maskable exception report includes:
receiving from the computer system a notice of memory error; and
identifying the corrupt page in the main memory as an uncorrected error.

9. A computer program product comprising a computer readable storage medium having a set of instructions stored therein which, when executed by a processor, causes the processor to recover a computer system from a memory error by:
intercepting an non-maskable exception report within a computer system, the non-maskable exception report identifying a memory error including a memory address of a corrupt page in a main memory of the computer system;
causing at least one of a firmware of the computer system and an operating system of the computer system to search a set of cached data for a replacement copy of the corrupt page, the replacement copy being a clean dataset corresponding to the corrupt page;
responsive to locating the replacement copy, retrieving the replacement copy;
storing the replacement copy in the memory; and
recovering the computer system from the memory error.

10. The computer program product of claim 9, wherein recovering the computer system from the memory error is performed with no data loss by replacing the corrupt page with the replacement copy.

11. The computer program product of claim 10, wherein replacing the corrupt page includes updating data structures to point to a new memory location.

12. The computer program product of claim 11, wherein the data structures includes page table entries.

13. The computer program product of claim 9, further causing the processor to recover the computer system from a memory error by:
taking the corrupt page offline.

14. The computer program product of claim 9, wherein the memory error is an uncorrected error not corrected by hardware.

15. The computer program product of claim 14, wherein the memory error is a dynamic random-access memory (DRAM) error.

16. The computer program product of claim 9, wherein intercepting a non-maskable exception report includes:
receiving from the computer system a notice of memory error; and
identifying the corrupt page in the main memory as an uncorrected error.

17. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to recover a computer system from a memory error by:
intercepting a non-maskable exception report within a computer system, the non-maskable exception report identifying a memory error including a memory address of a corrupt page in a main memory of the computer system;
causing at least one of a firmware of the computer system and an operating system of the computer system to search a set of cached data for a replacement copy of the corrupt page, the replacement copy being a clean dataset corresponding to the corrupt page;
responsive to locating the replacement copy, retrieving the replacement copy;
storing the replacement copy in the memory; and
recovering the computer system from the memory error.

18. The computer system of claim 17, wherein recovering the computer system from the memory error is performed with no data loss by replacing the corrupt page with the replacement copy.

19. The computer system of claim 17, further causing the processor to recover the computer system from a memory error by:
taking the corrupt page offline.

20. The computer system of claim 17, wherein the memory error is an uncorrected error not corrected by hardware.
